(19) United States
(12) Patent Application Publication
(10) Pub. No.: US 2025/0310784 A1
(43) Pub. Date: Oct. 2, 2025

(54) RADIO ZONE DESIGN APPARATUS, RADIO ZONE DESIGN METHOD, AND PROGRAM

(71) Applicant: NIPPON TELEGRAPH AND TELEPHONE CORPORATION, Tokyo (JP)

(72) Inventors: Toshiro NAKAHIRA, Tokyo (JP); Daisuke MURAYAMA, Tokyo (JP); Motoharu SASAKI, Tokyo (JP); So TAKATANI, Tokyo (JP); Takatsune MORIYAMA, Tokyo (JP)

(21) Appl. No.: 18/863,120

(22) PCT Filed: Jun. 30, 2022
(86) PCT No.: PCT/JP2022/026404

§ 371 Date: Nov. 5, 2024

(51) Int. Cl. H04W 16/26; H04W 16/18

(52) U.S. Cl. CPC H04W 16/26; H04W 16/18

(57) ABSTRACT

A station placement design device for designing arrangement of a base station and a reflector for constructing a radio area, the station placement design device including a processor that executes arranging terminal positions and candidate positions for an installation position of the base station or the reflector in the radio area; calculating received power between the terminal position and the candidate positions and received power between the candidate positions; selecting a candidate position for the base station from among the candidate positions; selecting, if there is a terminal position that is unable to be accommodated by the candidate position for the base station, a candidate position for the reflector capable of accommodating the terminal position; and determining arrangement of the base station and the reflector in which a cost of the radio area is minimized.

### TECHNICAL FIELD

The present invention relates to a station placement design device, a station placement design method, and a program.

### BACKGROUND ART

A station placement design device has been known that designs an appropriate installation position of a radio base station for constructing a radio area. In addition, with the increasing use of high frequency bands in radio communication systems, the influence of attenuation and shielding increases, and technical studies have been conducted on station placement design utilizing a reflector.

For example, in Non Patent Literature 1, studies have been made such as a method of converting a fluctuating NLOS area into a line-of-sight area without adding a base station by installing a metal reflective plate whose reflection direction can be controlled in the area, and an area shift technique for maximizing the number of terminals in the NLOS environment.

### CITATION LIST

### Non Patent Literature

Non Patent Literature 1: Shirasaka et al., “A Study on Received Power Improvement in NLOS Region for 28-GHz Band Indoor Wireless System Using Metal Reflector”, IEICE Technical Report, vol.121, no.391, RCS2021-271, pp.108-113, March 2022

### SUMMARY OF INVENTION

### Technical Problem

In the related art, station placement design of a reflector with respect to an already arranged base station has been studied, but it is not possible to perform station placement design that meets necessary communication requirements at low cost by combining the base station and a reflector.

Embodiments of the present invention have been made in view of the above problem, and an intention is to enable station placement design that meets necessary communication requirements at low cost by combining a base station and a reflector.

### Solution to Problem

In order to solve the above problem, a station placement design device according to an embodiment of the present invention is a station placement design device that designs arrangement of a base station and a reflector for constructing a radio area, and includes: an arrangement unit configured to arrange a plurality of terminal positions that are evaluation points and a plurality of candidate positions that are candidates for an installation position of the base station or the reflector in the radio area including a shielding object; a calculation unit configured to calculate received power between each of the terminal positions and each of the candidate positions and received power between each of the candidate positions and each of other candidate positions; a first selection unit configured to select, for each of different numbers of base stations, a candidate position for the base station of the number of base stations from among the plurality of candidate positions; a second selection unit configured to select, in a case where there is a terminal position that is not able to be accommodated by the candidate position for the base station among the plurality of terminal positions, a candidate position for the reflector capable of accommodating, in combination with the candidate position for the base station, the terminal position that is not able to be accommodated, and an orientation of the reflector; and a determination unit configured to determine arrangement of the base station and the reflector in which a cost of the wireless area is minimized from among candidate positions of the base station, or combinations of the candidate position for the base station, the candidate position for the reflector, and the orientation of the reflector.

### Advantageous Effects of Invention

According to the embodiment of the present invention, it becomes possible to perform station placement design that meets necessary communication requirements at low cost by combining a base station and a reflector.

### BRIEF DESCRIPTION OF DRAWINGS

FIG. 1 is a diagram illustrating a configuration example of a station placement design device according to a present embodiment.

FIG. 2 is a flowchart illustrating an example of station placement design processing according to the present embodiment.

FIG. 3 is a diagram (1) for explaining the station placement design processing according to the present embodiment.

FIG. 4 is a diagram (2) for explaining the station placement design processing according to the present embodiment.

FIG. 5 is a diagram (3) for explaining the station placement design processing according to the present embodiment.

FIG. 6 is a diagram illustrating an example of an evaluation list according to the present embodiment.

FIG. 7 is a flowchart illustrating an example of second selection processing according to Example 1.

FIG. 8 is a flowchart illustrating an example of second selection processing according to Example 2.

FIG. 9 is a flowchart illustrating an example of first selection processing according to the present embodiment.

FIG. 10 is a flowchart illustrating another example of the first selection processing according to the present embodiment.

FIG. 11 is a diagram illustrating an example of a hardware configuration of the station placement design device according to the present embodiment.

### DESCRIPTION OF EMBODIMENTS

An embodiment of the present invention (present embodiment) is described below with reference to the drawings. The embodiment described below is merely an example, and embodiments to which the present invention is applied are not limited to the following embodiment.

### Configuration Example of Station Placement Design Device

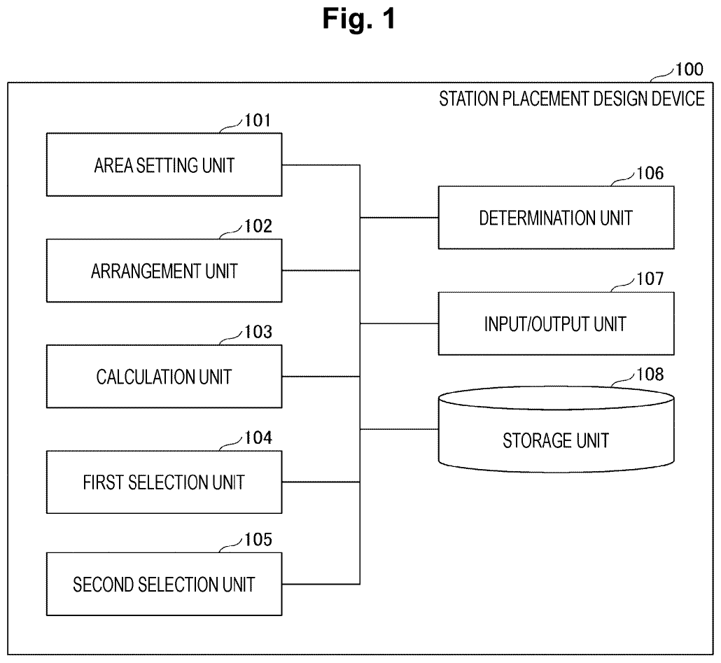

FIG. 1 is a diagram illustrating a configuration example of a station placement design device according to the present embodiment. A station placement design device 100 is an information processing device having a configuration of a computer or a system including a plurality of computers. The station placement design device 100 performs station placement design of designing arrangement of a base station and a reflector for constructing a wireless area. Here, the reflector is, for example, a reflective plate or the like that improves a problem that radio waves do not reach a place other than the line of sight and enables direction control of the reflected wave. Preferably, the reflector selectively reflects radio waves in a predetermined frequency band.

In the station placement design device 100, for example, a computer included in the station placement design device 100 executes a program stored in a storage medium or the like, thereby implementing an area setting unit 101, an arrangement unit 102, a calculation unit 103, a first selection unit 104, a second selection unit 105, a determination unit 106, an input/output unit 107, and the like. Note that at least some of the functional components described above may be implemented by hardware. In addition, the station placement design device 100 implements the storage unit 108 by, for example, a storage device of the computer included in the station placement design device 100.

The area setting unit 101 sets a radio area to be designed. The radio area to be designed includes, for example, an object such as a wall, a desk, or a shelf serving as a shielding object. For example, the area setting unit 101 may set a radio area to be designed on the basis of a building database (DB) representing structure of a building, three-dimensional computer aided design (CAD), or the like. Alternatively, the area setting unit 101 may set a radio area to be designed on the basis of three-dimensional data or the like obtained by Light Detection And Ranging (or Laser Imaging Detection And Ranging) (LiDAR) or a three-dimensional sensor such as a depth camera.

The arrangement unit 102 executes arrangement processing of arranging a plurality of terminal positions that are evaluation points for evaluating received power and a plurality of candidate positions that are candidates for an installation position of a base station or a reflector, in the radio area to be designed.

The calculation unit 103 executes calculation processing of calculating received power between each of the terminal positions and each of the candidate positions arranged by the arrangement unit 102 and received power between each of the candidate positions and each of other candidate positions. For example, the calculation unit 103 calculates received power received from each candidate position at each terminal position by using a radio wave propagation simulation technique such as ray trace. In addition, in the present embodiment, received power received from each of the other candidate positions is further calculated at each candidate position.

The first selection unit 104 executes first selection processing of selecting, for each number of different numbers n of base stations (for example, n=1 to N, and N is an integer greater than or equal to 2), candidate positions for the n base stations from among a plurality of candidate positions. For example, the first selection unit 104 divides the plurality of terminal positions arranged by the arrangement unit 102 into clusters of the number of base stations n, and selects, for each of the divided clusters, a candidate position of the base station such that more terminal positions satisfy a predetermined communication quality (for example, received power). Alternatively, the first selection unit 104 selects, by a greedy algorithm, a candidate position for the base station in order from a candidate position for the base station such that more terminal positions satisfy a predetermined communication quality until the number of base stations n is reached.

In a case where there is a terminal position that cannot be accommodated by the candidate position of the base station selected by the first selection unit 104 among the plurality of terminal positions, the second selection unit 105 selects a candidate position for a reflector capable of accommodating, in combination with the candidate position of the base station, the terminal position that cannot be accommodated, and also an installation direction of the reflector. Note that the installation direction of the reflector is an example of an orientation of the reflector.

For example, on the basis of the received power calculated by the calculation unit 103, the second selection unit 105 extracts a candidate position capable of accommodating a terminal position that cannot be accommodated from among candidate positions excluding the candidate position for the base station selected by the first selection unit 104 among the plurality of candidate positions. In addition, at the extracted candidate position, the second selection unit 105 calculates reflector transmission power from radio wave propagation attenuation from the candidate position for the base station to the extracted candidate position and a reflectance of the reflector. Furthermore, on the basis of the calculated reflector transmission power, the second selection unit 105 sets, as the candidate position of the reflector, a candidate position in which the received power at the terminal position that cannot be accommodated is greater than or equal to a predetermined value among extracted candidate positions.

In addition, for example, the second selection unit 105 sets, as the installation direction of the reflector, a bisector direction of an angle between a radio wave arrival direction vector with maximum power in a direction of the candidate position of the base station and a radio wave arrival direction vector with maximum power in a direction of the terminal position that cannot be accommodated, as viewed from the candidate position of the reflector. Alternatively, the second selection unit 105 may perform evaluation in a plurality of installation directions of the reflector installed at the candidate position for the reflector, and set, as the installation direction of the reflector, an installation direction in which received power from the reflector is maximized at the terminal position that cannot be accommodated.

The determination unit 106 executes determination processing of determining arrangement of the base station and the reflector in which a cost of the radio area is minimized from among the above-described candidate positions of the base station, or combinations of the candidate position of the base station, the candidate position of the reflector, and the installation direction of the reflector. For example, the determination unit 106 determines the installation position of the base station, the installation position of the reflector, and the installation direction of the reflector with which the cost of the radio area is minimized.

The input/output unit 107 executes, for example, output processing of outputting installation methods of the base station and the reflector determined by the determination unit 106 to an external device, input processing of receiving an input of design conditions and the like from the external device, and the like.

The storage unit 108 stores, for example, data of the radio area set by the area setting unit 101, data of the plurality of terminal positions and the plurality of candidate positions arranged by the arrangement unit 102, data of the received power calculated by the calculation unit 103, and the like. In addition, the storage unit 108 stores the candidate position of the base station selected by the first selection unit 104, the candidate position and the installation direction of the reflector selected by the second selection unit 105, and the like.

Note that the functional configuration of the station placement design device 100 illustrated in FIG. 1 is an example. For example, the storage unit 108 may be implemented by a storage server, a cloud service, or the like accessible by the station placement design device 100 via a communication network. In addition, the functional components of the station placement design device 100 may be implemented not only by a physical machine (computer), but also by, for example, a program executed by a virtual machine on a cloud. Further, the functional components of the station placement design device 100 may be provided in a plurality of information processing devices in a distributed manner.

### Flow of Processing

Next, a processing flow of a station placement design method according to the present embodiment is described.

### Station Placement Design Processing

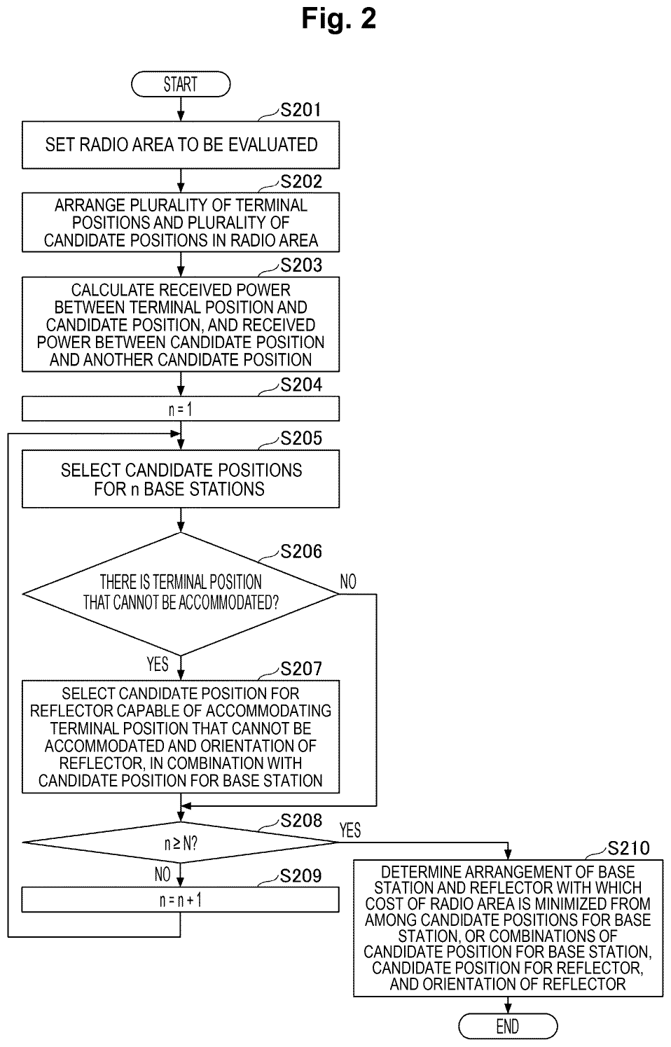

FIG. 2 is a flowchart illustrating an example of station placement design processing according to the present embodiment. This processing illustrates, for example, an example of the station placement design processing executed by the station placement design device 100 described with reference to FIG. 1.

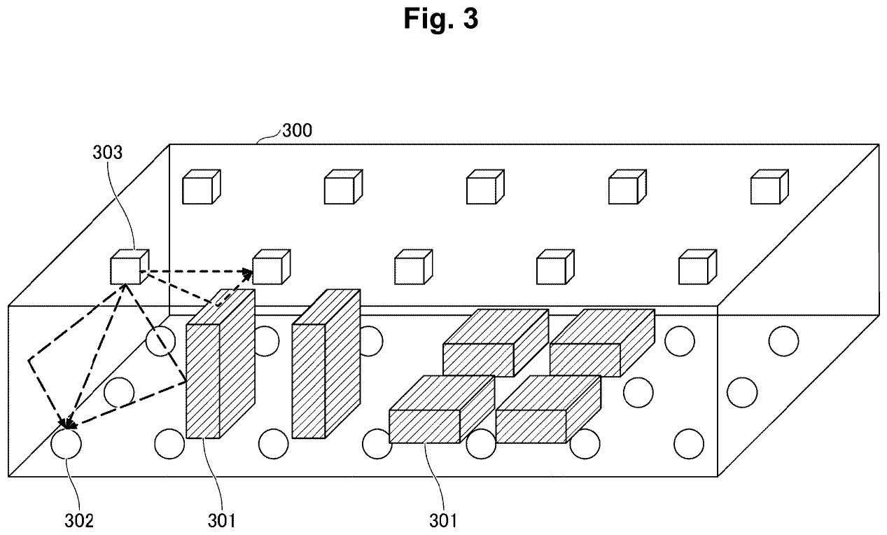

In step S201, the area setting unit 101 of the station placement design device 100 sets a radio area to be designed. As an example, as illustrated in FIG. 3, the area setting unit 101 sets a radio area 300 in an indoor area where a plurality of shielding objects 301 is arranged. Note that the radio area 300 set by the area setting unit 101 has, for example, three-dimensional coordinates based on three-dimensional CAD data, three-dimensional data acquired by a three-dimensional sensor, or the like.

In step S202, the arrangement unit 102 of the station placement design device 100 arranges, for example, as illustrated in FIG. 3, a plurality of terminal positions 302 that are evaluation points for evaluating radio quality such as received power, in the radio area 300 set by the area setting unit 101. In addition, the arrangement unit 102 arranges, in the radio area 300, for example, as illustrated in FIG. 3, a plurality of candidate positions 303 that are candidates for installation positions of the base station or the reflector.

In step S203, the calculation unit 103 of the station placement design device 100 calculates received power between a terminal position 302 and a candidate position 303 arranged by the arrangement unit 102, and received power between a candidate position 303 and another candidate position 303. For example, as illustrated in FIG. 3, the calculation unit 103 calculates the received power between the terminal position 302 and the candidate position 303 by radio wave propagation simulation such as ray trace. In ray trace, radio waves (rays) transmitted from a transmission point are reflected or diffracted by a structure that is present on the way to a reception point are traced as tracks of the respective rays, and powers of all the rays that have reached the reception point are added up, whereby intensity of the radio waves at the reception point is estimated. Note that ray trace is also referred to as ray tracing. Similarly, the calculation unit 103 calculates received power for all combinations of the terminal position 302 and the candidate position 303 and of the candidate position 303 and the other candidate position 303.

The base station placement design device 100 initializes the number of base stations n to 1 in step S204, and executes the processing in and after step S205.

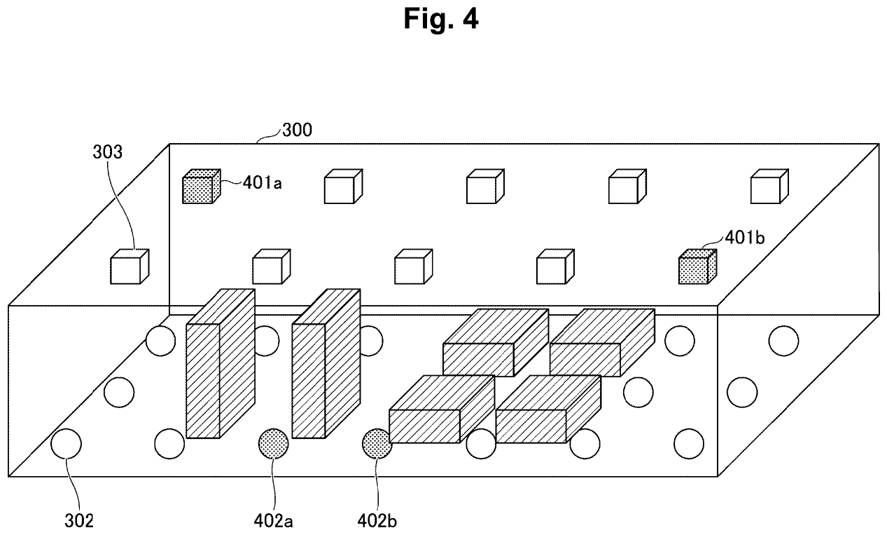

In step S205, the first selection unit 104 of the base station placement design device 100 selects candidate positions for n base stations from among the plurality of candidate positions 303. FIG. 4 illustrates an example of a case where the first selection unit 104 selects candidate positions 401a and 401b for two base stations from among the plurality of candidate positions 303 (a case where the number of base stations n is 2). Note that a specific example is described below of the first selection processing of selecting candidate positions for n base stations from among the plurality of candidate positions 303 by the first selection unit 104.

In step S206, the second selection unit 105 of the station placement design device 100 determines whether there is a terminal position 302 that cannot be accommodated by the base stations selected by the first selection unit 104. For example, in FIG. 4, it is assumed that received power from the candidate positions 401a and 401b of the base stations selected by the first selection unit 104 is less than or equal to a predetermined value at the terminal positions 402a and 402b. In this case, the second selection unit 105 determines that there is the terminal position 302 that cannot be accommodated by the base stations selected by the first selection unit 104.

In a case where there is the terminal position 302 that cannot be accommodated, the second selection unit 105 causes the processing to proceed to step S207. In contrast, in a case where there is no terminal position 302 that cannot be accommodated, the second selection unit 105 causes the processing to proceed to step S208.

When the processing proceeds to step S207, the second selection unit 105 selects a candidate position for a reflector capable of accommodating a terminal position that cannot be accommodated, and an orientation (installation direction) of the reflector, in combination with the candidate position for the base station selected by the first selection unit 104.

For example, in FIG. 4, it is assumed that the terminal positions 402a and 402b cannot be accommodated by the candidate positions 401a and 401b of the base stations selected by the first selection unit 104 (received power is less than or equal to the predetermined value).

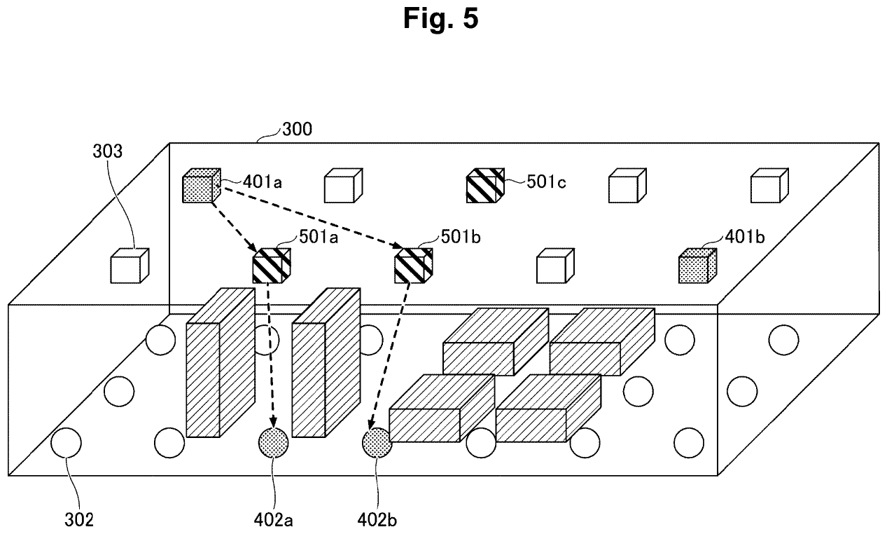

In this case, as illustrated in FIG. 5, the second selection unit 105 extracts a candidate position 501a capable of accommodating the terminal position 402a that cannot be accommodated from among the candidate positions 303 excluding the candidate positions 401a and 401b of the base stations among the plurality of candidate positions 303. For example, on the basis of the received power calculated by the calculation unit 103, the second selection unit 105 extracts the candidate position 501a in which the received power at the terminal position 402a that cannot be accommodated is greater than or equal to the predetermined value, among the candidate positions 303 excluding the candidate positions 401a and 401b for the base stations. In addition, at the extracted candidate position 501a, the second selection unit 105 calculates reflector transmission power from radio wave propagation attenuation from the candidate positions 401a and 401b for the base stations to the extracted candidate position 501a and the reflectance of the reflector. Furthermore, on the basis of the calculated reflector transmission power, the second selection unit 105 sets, as the candidate position for the reflector corresponding to the terminal position 402a that cannot be accommodated, a candidate position (for example, the candidate position 501a) in which the received power at the terminal position 402a that cannot be accommodated is greater than or equal to the predetermined value among the extracted candidate positions.

Furthermore, the second selection unit 105 determines an installation direction of the reflector installed at the candidate position 501a of the reflector. For example, the second selection unit 105 obtains a radio wave arrival direction vector with maximum power in a direction of the candidate position 401a of the base station and a radio wave arrival direction vector with maximum power in a direction of the terminal position 402a that cannot be accommodated, as viewed from the candidate position 501a of the reflector. In addition, the second selection unit 105 sets, as the installation direction of the reflector, a bisector direction of an angle between the radio wave arrival direction vector with the maximum power in the direction of the candidate position 401a of the base station and the radio wave arrival direction vector with the maximum power in the direction of the terminal position 402a that cannot be accommodated. Alternatively, the second selection unit 105 may perform evaluation in a plurality of installation directions of the reflector installed at the candidate position 501a of the reflector, and set, as the installation direction of the reflector, an installation direction in which received power from the reflector is maximized at the terminal position 402a that cannot be accommodated.

The second selection unit 105 executes similar processing on each of terminal devices that cannot be accommodated. For example, on the basis of the received power calculated by the calculation unit 103, the second selection unit 105 extracts the candidate positions 501b and 501c in which received power at the terminal position 402b that cannot be accommodated is greater than or equal to the predetermined value among the candidate positions 303 excluding the candidate positions 401a and 401b for the base stations. In addition, at the extracted candidate positions 501b and 501c, the second selection unit 105 calculates reflector transmission power from radio wave propagation attenuation from the candidate positions 401a and 401b for the base stations to the extracted candidate positions 501b and 501c, and the reflectance of the reflector. Furthermore, on the basis of the calculated reflector transmission power, the second selection unit 105 sets, as the candidate position for the reflector corresponding to the terminal position 402b that cannot be accommodated, a candidate position (for example, the candidate position 501b) in which the received power at the terminal position 402b that cannot be accommodated is greater than or equal to the predetermined value among the extracted candidate positions.

Furthermore, the second selection unit 105 determines an installation direction of the reflector installed at the candidate position 501b for the reflector in the same manner as the installation direction of the reflector installed at the candidate position 501a of the reflector described above.

When the processing proceeds to step S208, the station placement design device 100 determines whether a value of n is greater than or equal to the maximum value N of the number of base stations that can be arranged in the radio area 300. In a case where the value of n is greater than or equal to N, the station placement design device 100 causes the processing to proceed to step S210. In contrast, in a case where the value of n is not greater than or equal to N, the station placement design device 100 causes the processing to proceed to step S209. Note that a value of N is set in advance in the station placement design device 100 by a designer or the like.

When the processing proceeds to step S209, the station placement design device 100 adds 1 to n, and returns the processing to step S205.

By the processing of steps S204 to S209, the station placement design device 100 can select, for each of different numbers of base stations (numbers of base stations 1, 2, 3, . . . , N), a candidate position for the base station, or a candidate position for the base station, a candidate position for the reflector, and an installation direction of the reflector.

When the processing proceeds to step S210, the determination unit 106 of the station placement design device 100 determines arrangement of the one or more base stations and the one or more reflectors with which a cost of the radio area 300 is minimized from among one or more candidate positions for the one or more base stations, or combinations of the one or more candidate positions for the one or more base stations, the one or more candidate positions for the one or more reflectors, and the one or more orientations (one or more installation directions) of the one or more reflectors.

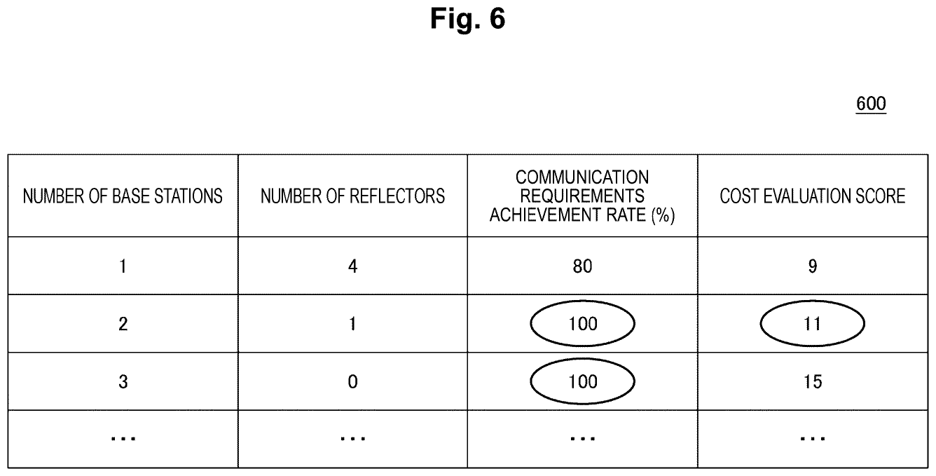

For example, the determination unit 106 compiles evaluation results at the candidate position for the base station and the candidate position for the reflector and the installation direction of the reflector selected for different numbers of base stations in steps S204 to S209 into an evaluation list 600 as illustrated in FIG. 6. In the example of FIG. 6, the evaluation list 600 includes information such as “number of base stations,” “number of reflectors,” “communication requirement achievement rate (%),” and “cost evaluation score” as items.

The “number of base stations” corresponds to the above-described number of base stations n. The “number of reflectors” is, for example, the number of reflectors selected in step S207 in FIG. 2 for each “number of base stations”. The “communication requirement achievement rate (%)” is, for example, an achievement rate of a communication requirement corresponding to a combination of the “number of base stations” and the “number of reflectors” (for example, a ratio of the terminal positions 302 that satisfy a communication requirement among the plurality of terminal positions 302). The “cost evaluation score” is an evaluation score for evaluating a cost for constructing the radio area 300. As an example, in a case where a cost of the base station is five times a cost of the reflector, the determination unit 106 may calculate the cost evaluation score of the radio area 300 by the following Formula (1).

Cost evaluation score=(the number of base stations×5)+the number of reflectors (Formula 1)

In addition, the determination unit 106 determines, from the evaluation list 600, arrangement of the base station and the reflector with which the cost evaluation score of the radio area 300 is minimized while satisfying the communication requirement achievement rate required for the radio area 300. For example, in the evaluation list 600 illustrated in FIG. 6, in a case where the communication requirement achievement rate required in the radio area 300 is 100%, the determination unit 106 determines, as the arrangement of the base station and the reflector, the candidate position for the base station and the candidate position for the reflector and installation direction of the reflector in a case where the number of base stations is 2.

By the processing described with reference to FIGS. 2 to 6, the station placement design device 100 according to the present embodiment can perform station placement design that meets necessary communication requirements at low cost by combining a base station and a reflector.

### Second Selection Processing

Next, an example of specific processing of the second selection processing executed by the second selection unit 105 is described.

### Example 1

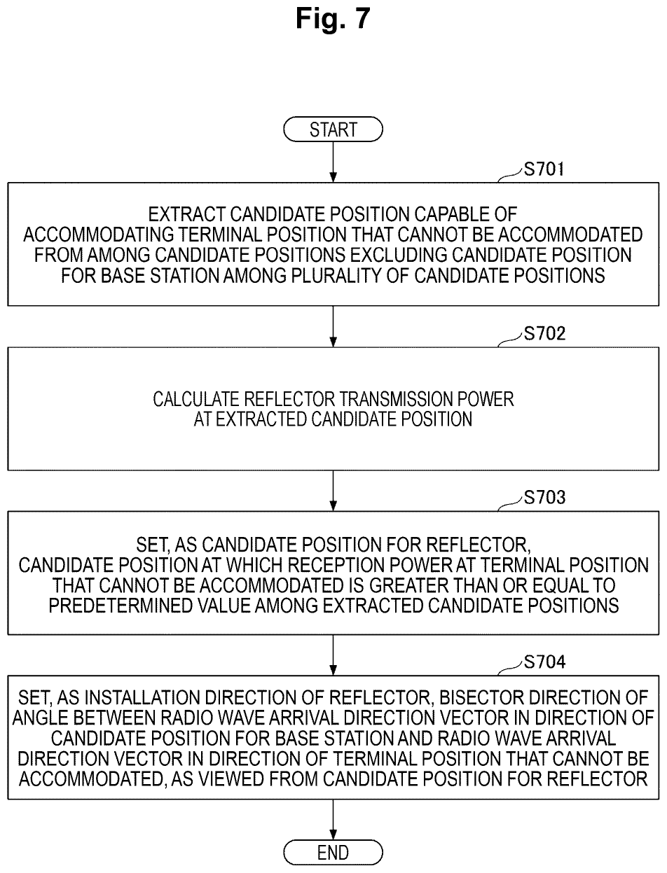

FIG. 7 is a flowchart illustrating an example of second selection processing according to Example 1. This processing illustrates an example of the second selection processing executed by the second selection unit 105 of the station placement design device 100 in step S207 in FIG. 2, for example. For example, in a case where there is the terminal position 302 that cannot be accommodated by the candidate position for the base station selected by the first selection unit 104 in step S205 in FIG. 2, the second selection unit 105 executes the processing illustrated in FIG. 7 on each of the terminal positions 302 that cannot be accommodated.

In step S701, the second selection unit 105 extracts the candidate position 303 capable of accommodating a terminal position that cannot be accommodated from among the candidate positions 303 excluding the candidate position for the base station selected by the first selection unit 104 among the plurality of candidate positions 303. For example, on the basis of the received power calculated by the calculation unit 103, the second selection unit 105 extracts the candidate position 303 in which the received power at the terminal position that cannot be accommodated is greater than or equal to the predetermined value.

In step S702, at the extracted candidate position 303, the second selection unit 105 calculates reflector transmission power from radio wave propagation attenuation from the candidate position for the base station to the extracted candidate position 303 and the reflectance of the reflector.

In step S703, on the basis of the calculated reflector transmission power, the second selection unit 105 sets, as the candidate position for the reflector, the candidate position 303 in which the received power at the terminal position that cannot be accommodated is greater than or equal to the predetermined value among the extracted candidate positions 303.

In step S704, the second selection unit 105 sets, as the installation direction of the reflector, a bisector direction of an angle between a radio wave arrival direction vector with maximum power in a direction of the candidate position for the base station and a radio wave arrival direction vector with maximum power in a direction of the terminal position that cannot be accommodated, as viewed from the candidate position for the reflector.

By the processing in FIG. 7, the second selection unit 105 can select the candidate position and the installation direction of the reflector capable of accommodating, in combination with the candidate position for the base station, the terminal position that cannot be accommodated.

### Example 2

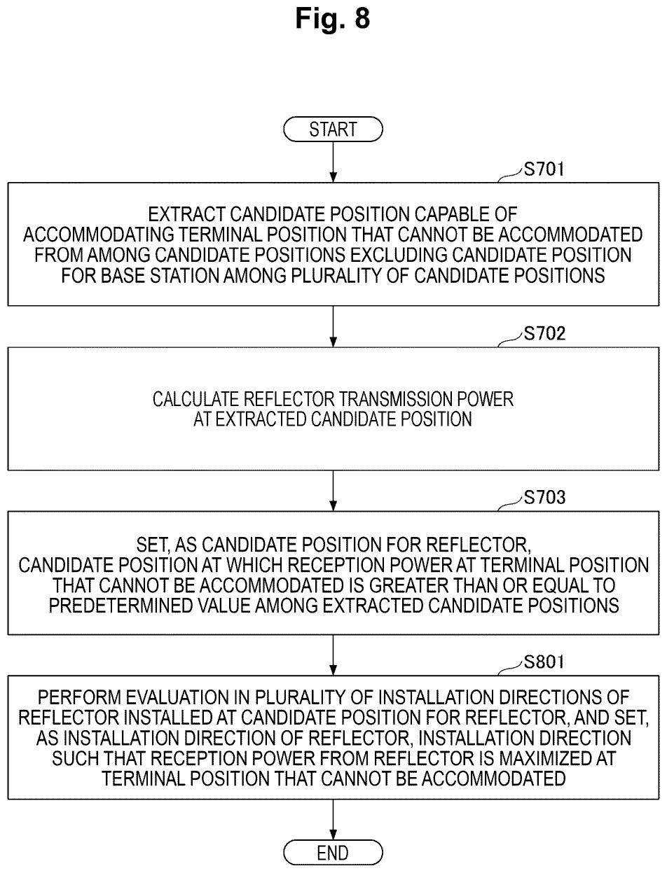

FIG. 8 is a flowchart illustrating an example of second selection processing according to Example 2. This processing illustrates another example of the second selection processing executed by the second selection unit 105 of the station placement design device 100 in step S207 in FIG. 2, for example. For example, in a case where there is the terminal position 302 that cannot be accommodated by the candidate position for the base station selected by the first selection unit 104 in step S205 in FIG. 2, the second selection unit 105 executes the processing illustrated in FIG. 8 on each of the terminal positions 302 that cannot be accommodated.

Note that, in the processing illustrated in FIG. 8, the processing of steps S701 to S703 is similar to the second selection processing according to Example 1 described with reference to FIG. 7, and, thus, description thereof is omitted here.

In step S801, the second selection unit 105 performs evaluation in a plurality of installation directions of the reflector installed at the candidate position for the reflector, and sets, as the installation direction of the reflector, an installation direction in which received power from the reflector is maximized at the terminal position that cannot be accommodated.

By the processing in FIG. 8, the second selection unit 105 can select the candidate position and the installation direction of the reflector capable of accommodating, in combination with the candidate position for the base station, the terminal position that cannot be accommodated.

### First Selection Processing

Next, an example of specific processing of the first selection processing executed by the first selection unit 104 is described.

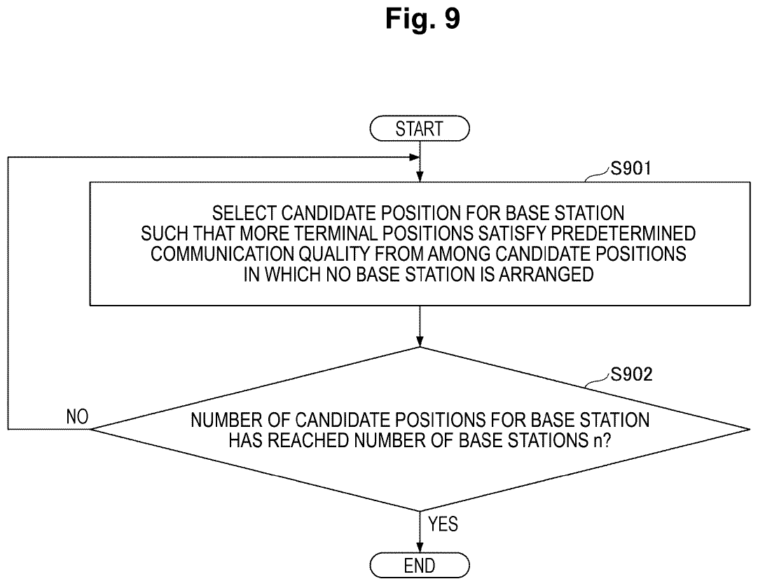

FIG. 9 is a flowchart illustrating an example of the first selection processing according to the present embodiment. This processing illustrates an example of the first selection processing executed by the first selection unit 104 of the station placement design device 100 in step S205 in FIG. 2, for example.

In step S901, the first selection unit 104 selects a candidate position for the base station in which more terminal positions 302 satisfy a predetermined communication quality from among the candidate positions 303 in which no base station is arranged.

In step S902, the first selection unit 104 determines whether the number of selected candidate positions for the base station has reached the number of base stations n. In a case where the number of candidate positions for the base station has not reached the number of base stations n, the first selection unit 104 returns the processing to step S701. In contrast, in a case where the number of candidate positions for the base station has reached the number of base stations n, the first selection unit 104 ends the processing in FIG. 7.

As described above, the first selection unit 104 may select candidate positions for n base stations by selecting, e.g., by using a greedy method, candidate positions 303 for the base stations until the number of candidate positions 303 reaches the number of base stations n, such that more terminal positions 302 satisfy the required communication quality.

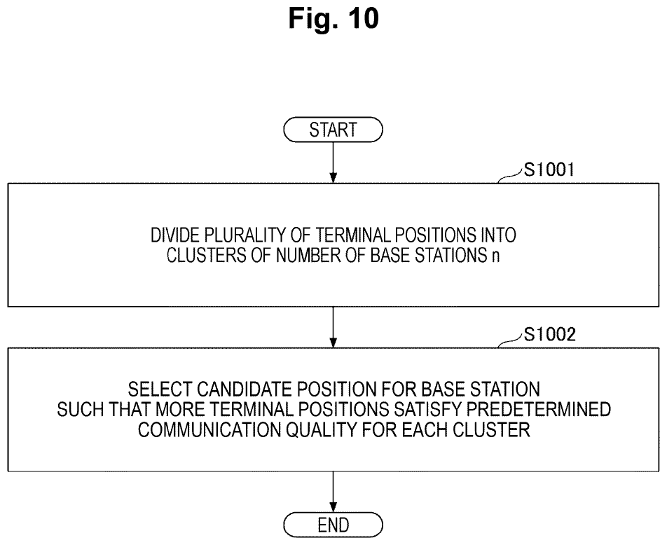

FIG. 10 is a flowchart illustrating another example of the first selection processing according to the present embodiment. This processing illustrates another example of the first selection processing executed by the first selection unit 104 of the station placement design device 100 in step S205 in FIG. 2, for example.

In step S1001, the first selection unit 104 divides the plurality of terminal positions 302 into clusters of the number of base stations n. As an example, the first selection unit 104 divides the plurality of terminal positions 302 into the clusters of the number of base stations n by using a known clustering method such as a k-means clustering. Note that the clustering method is not limited to the k-means clustering, and non-hierarchical and hierarchical clustering methods can be applied.

In step S1002, the first selection unit 104 selects, for each divided cluster, a candidate position 303 for a base station such that more terminal positions 302 satisfy a predetermined communication quality.

In this manner, for example, the first selection unit 104 may divide the plurality of terminal positions 302 into the clusters of the number of base stations n, and select, for each cluster, the candidate position 303 for the base station such that a required communication quality is satisfied at more terminal positions 302.

Although the station placement design device 100 and the station placement design method according to the present embodiment have been described above, the station placement design device 100 and the station placement design method according to the present invention can be variously modified and applied.

For example, in each of the above descriptions, it is described that the plurality of candidate positions 303 are positions (coordinates) of the base stations or the reflectors, but the plurality of candidate positions 303 may be represented by combinations of the position of the base station or the reflector and an installation direction (or an orientation of an antenna, or the like).

In addition, although the description has been made assuming a single radio communication scheme so far, a plurality of radio communication schemes may be used in combination that differ for each base station. Note that, in that case, fair evaluation across radio communication schemes cannot be made with the received power, and, thus, the station placement design device 100 may perform communication quality evaluation after performing conversion into a comparable index such as a wireless transmission rate expected value.

Furthermore, the description is made assuming that the installation direction of the reflector cannot be changed after installation so far. However, not limited thereto, for example, in step S207 in FIG. 2, the second selection unit 105 may assume that the installation direction of the reflector can be controlled from a remote place or the like when selecting the candidate position for the reflector, and select the installation position of the reflector in consideration of a control range.

In addition, the description is made assuming that the orientation of the reflector is the installation direction of the reflector so far, but the orientation of the reflector may be the reflection direction of the reflector, or the like. For example, it is also conceivable to use a reflector capable of changing the reflection direction of the radio wave using metamaterial technology or the like. In this case, by selecting the reflection direction of the reflector such that the radio wave is reflected and reaches between a base station and a terminal, it is possible to achieve an effect similar to that in the case of selecting the installation direction of the reflector. For example, in step S801 in FIG. 8, the second selection unit 105 may perform evaluation in a plurality of reflection directions of the reflector installed at the candidate position for the reflector, and set, as the orientation of the reflector, the reflection direction in which the received power from the reflector is maximized at the terminal position that cannot be accommodated. As described above, the orientation of the reflector may be the installation direction of the reflector or the reflection direction of the reflector. Furthermore, the orientation of the reflector may be expressed by a combination of the installation direction of the reflector and the reflection direction of the reflector, or the like.

Furthermore, in steps S204 to S209 in FIG. 2, the station placement design device 100 acquires station placement design evaluation results in a general way while increasing the number of base stations within a range designated in advance, and then performs the station placement design from among them. However, not limited thereto, the station placement design device 100 may acquire a station placement design evaluation result each time while increasing the number of base stations, and, if there is a station placement design evaluation result satisfying all conditions determined in advance, set the station placement design result as a final solution, and terminate the subsequent arithmetic processing.

### Hardware Configuration Example

### Hardware Configuration of Station Placement Design Device

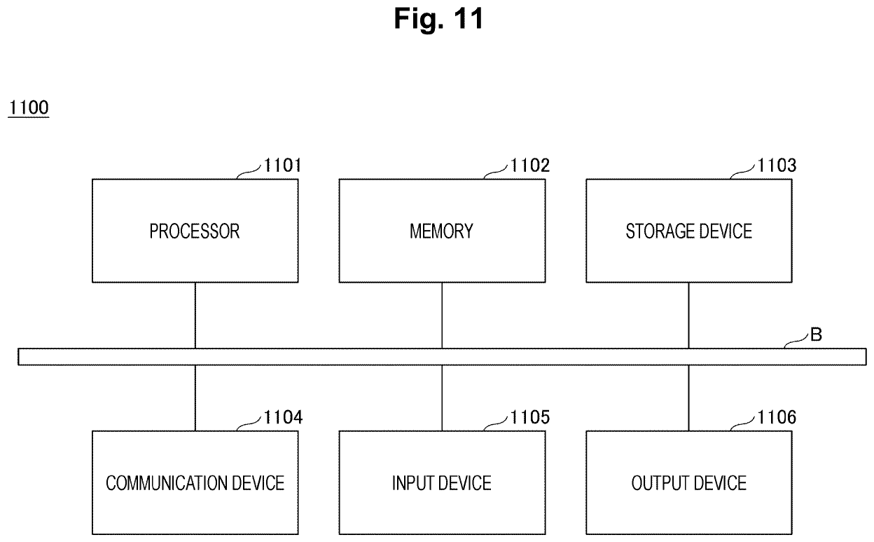

FIG. 11 is a diagram illustrating an example of a hardware configuration of the station placement design device according to the present embodiment. The station placement design device 100 has, for example, a hardware configuration of a computer 1100 as illustrated in FIG. 11. In the example of FIG. 11, the computer 1100 includes a processor 1101, a memory 1102, a storage device 1103, a communication device 1104, an input device 1105, an output device 1106, a bus B, and the like.

The processor 1101 is, for example, an arithmetic device such as a central processing unit (CPU) that implements various functions by executing a predetermined program. The memory 1102 is a storage medium readable by the computer 1100, and includes, for example, a random access memory (RAM) or a read only memory (ROM). The storage device 1103 is a computer-readable storage medium, and can include, for example, a hard disk drive (HDD), a solid state drive (SSD), various optical discs, and a magneto-optical disk.

The communication device 1104 includes one or more pieces of hardware (communication devices) for communicating with other devices via a wireless or wired network. The input device 1105 is an input device (for example, a keyboard, a mouse, a microphone, a switch, a button, or a sensor) that receives an input from the outside. The output device 1106 is an output device (for example, a display, a speaker, or an LED lamp) that performs output to the outside. Note that the input device 1105 and the output device 1106 may be integrated (for example, an input/output device such as a touch panel display).

The bus B is commonly connected to the above-described components, and transmits, for example, an address signal, a data signal, and various control signals. Note that the processor 1101 is not limited to a CPU, and may be, for example, a digital signal processor (DSP), a programmable logic device (PLD), or a field programmable gate array (FPGA).

### Supplement

The station placement design device 100 in the present embodiment is not limited to implementation by a dedicated device, and may be implemented by a general-purpose computer. In that case, a program for implementing the functions may be recorded in a computer-readable recording medium, and the functions may be implemented by loading the program recorded in this recording medium to a computer system, and executing the program. Note that, the “computer system” referred to herein includes an OS and hardware such as peripheral devices.

In addition, the “computer-readable recording medium” includes various storage devices such as a portable medium such as a flexible disk, a magneto-optical disk, a ROM, and a CD-ROM, and a hard disk built into a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case.

In addition, the program may be for implementing some of the above-described functions, may be capable of implementing the above-described functions in combination with a program already recorded in a computer system, or may be implemented by using hardware such as a programmable logic device (PLD) or a field programmable gate array (FPGA).

### Effects of Embodiment

According to the present embodiment, it becomes possible to perform station placement design that meets necessary communication requirements at low cost by combining the base station and the reflector.

### Conclusion of Embodiment

The present specification discloses at least the following station placement design device, station placement design method, and program.

### Clause 1

A station placement design device that designs arrangement of a base station and a reflector for constructing a radio area,
the station placement design device including:
an arrangement unit configured to arrange a plurality of terminal positions that are evaluation points and a plurality of candidate positions that are candidates for an installation position of the base station or the reflector in the radio area including a shielding object;
a calculation unit configured to calculate received power between each of the terminal positions and each of the candidate positions and received power between each of the candidate positions and each of other candidate positions;
a first selection unit configured to select, for each of different numbers of base stations, a candidate position for the base station of the number of base stations from among the plurality of candidate positions;
a second selection unit configured to select, in a case where there is a terminal position that is not able to be accommodated by the candidate position for the base station among the plurality of terminal positions, a candidate position for the reflector capable of accommodating, in combination with the candidate position for the base station, the terminal position that is not able to be accommodated, and an orientation of the reflector; and
a determination unit configured to determine arrangement of the base station and the reflector in which a cost of the radio area is minimized from among candidate positions of the base station, or combinations of the candidate position for the base station, the candidate position for the reflector, and the orientation of the reflector.

### Clause 2

The station placement design device according to clause 1, in which
the orientation of the reflector includes an installation direction of the reflector, and
the second selection unit sets, as the installation direction of the reflector, a bisector direction of an angle between a radio wave arrival direction vector with maximum power in a direction of the candidate position for the base station and a radio wave arrival direction vector with maximum power in a direction of the terminal position that is not able to be accommodated, as viewed from the candidate position for the reflector.

### Clause 3

The station placement design device according to clause 1, in which
the orientation of the reflector includes an installation direction or a reflection direction of the reflector, and
the second selection unit performs evaluation in a plurality of installation directions or reflection directions of the reflector installed at the candidate position for the reflector, and sets, as an orientation of the reflector, an installation direction or a reflection direction in which received power from the reflector is maximized at the terminal position that is not able to be accommodated.

### Clause 4

The station placement design device according to any one of clauses 1 to 3, in which
the second selection unit
extracts the candidate position capable of accommodating the terminal position that is not able to be accommodated from among candidate positions excluding the candidate position for the base station among the plurality of candidate positions on the basis of the received power calculated by the calculation unit,
calculates, at the candidate position extracted, reflector transmission power from radio wave propagation attenuation from the candidate position for the base station to the candidate position extracted and a reflectance of the reflector; and
sets, as the candidate position for the reflector, a candidate position in which received power at the terminal position that is not able to be accommodated is greater than or equal to a predetermined value among candidate positions extracted, on the basis of the reflector transmission power.

### Clause 5

The station placement design device according to any one of clauses 1 to 3, in which the first selection unit divides the plurality of terminal positions into clusters of the number of base stations, and selects, for each of the clusters, the candidate position for the base station such that more terminal positions satisfy a predetermined communication quality.

### Clause 6

The station placement design device according to any one of clauses 1 to 3, in which the first selection unit selects the candidate position for the base station in order from the candidate position for the base station such that more terminal positions satisfy a predetermined communication quality until the number of base stations is reached.

### Clause 7

A station placement design method executed by a station placement design device that designs arrangement of a base station and a reflector for constructing a radio area,
the station placement design method including:
processing of arranging a plurality of terminal positions that are evaluation points and a plurality of candidate positions that are candidates for an installation position of the base station or the reflector in the radio area including a shielding object;
processing of calculating received power between each of the terminal positions and each of the candidate positions and received power between each of the candidate positions and each of other candidate positions;
processing of selecting, for each of different numbers of base stations, a candidate position for the base station of the number of base stations from among the plurality of candidate positions;
processing of selecting, in a case where there is a terminal position that is not able to be accommodated by the candidate position for the base station among the plurality of terminal positions, a candidate position for the reflector capable of accommodating, in combination with the candidate position for the base station, the terminal position that is not able to be accommodated, and an orientation of the reflector; and
processing of determining arrangement of the base station and the reflector in which a cost of the radio area is minimized from among candidate positions of the base station, or combinations of the candidate position for the base station, the candidate position for the reflector, and the orientation of the reflector.

### Clause 8

A program that causes a computer to execute the station placement design method according to clause 7.

The present embodiment is described above; however, the present invention is not limited to such a specific embodiment, and various modifications and changes can be made within the scope of the gist of the present invention described in the claims.

### REFERENCE SIGNS LIST

100 Station placement design device
102 Arrangement unit
103 Calculation unit
104 First selection unit
105 Second selection unit
106 Determination unit
300 Radio area
301 Shielding object
302 Terminal position
303 Candidate position
900 Computer

1. A station placement design device that designs arrangement of a base station and a reflector for constructing a radio area,
the station placement design device comprising:
a processor; and
a memory that includes instructions, which when executed, cause the processor to execute:
arranging a plurality of terminal positions that are evaluation points and a plurality of candidate positions that are candidates for an installation position of the base station or the reflector in the radio area including a shielding object;
calculating received power between each of the terminal positions and each of the candidate positions and received power between each of the candidate positions and each of other candidate positions;
first selecting, for each of different numbers of base stations, a candidate position for the base station of the number of base stations from among the plurality of candidate positions;
second selecting, in a case where there is a terminal position that is not able to be accommodated by the candidate position for the base station among the plurality of terminal positions, a candidate position for the reflector capable of accommodating, in combination with the candidate position for the base station, the terminal position that is not able to be accommodated, and an orientation of the reflector; and
determining arrangement of the base station and the reflector in which a cost of the radio area is minimized from among candidate positions of the base station, or combinations of the candidate position for the base station, the candidate position for the reflector, and the orientation of the reflector.

2. The station placement design device according to claim 1, wherein
the orientation of the reflector includes an installation direction of the reflector, and
the second selecting sets, as the installation direction of the reflector, a bisector direction of an angle between a radio wave arrival direction vector with maximum power in a direction of the candidate position for the base station and a radio wave arrival direction vector with maximum power in a direction of the terminal position that is not able to be accommodated, as viewed from the candidate position for the reflector.

3. The station placement design device according to claim 1, wherein
the orientation of the reflector includes an installation direction or a reflection direction of the reflector, and
the second selecting performs evaluation in a plurality of installation directions or reflection directions of the reflector installed at the candidate position for the reflector, and sets, as an orientation of the reflector, an installation direction or a reflection direction in which received power from the reflector is maximized at the terminal position that is not able to be accommodated.

4. The station placement design device according to claim 1, wherein
the second selecting
extracts the candidate position capable of accommodating the terminal position that is not able to be accommodated from among candidate positions excluding the candidate position for the base station among the plurality of candidate positions on a basis of the received power calculated by the calculation unit,
calculates, at the candidate position extracted, reflector transmission power from radio wave propagation attenuation from the candidate position for the base station to the candidate position extracted and a reflectance of the reflector; and
sets, as the candidate position for the reflector, a candidate position such that received power at the terminal position that is not able to be accommodated is greater than or equal to a predetermined value among candidate positions extracted, on a basis of the reflector transmission power.

5. The station placement design device according to claim 1, wherein the first selecting divides the plurality of terminal positions into clusters of the number of base stations, and selects, for each of the clusters, the candidate position for the base station such that more terminal positions satisfy a predetermined communication quality.

6. The station placement design device according to claim 1, wherein the first selecting selects the candidate position for the base station in order from the candidate position for the base station such that more terminal positions satisfy a predetermined communication quality until the number of base stations is reached.

7. A station placement design method executed by a station placement design device that designs arrangement of a base station and a reflector for constructing a radio area,
the station placement design method comprising:
arranging a plurality of terminal positions that are evaluation points and a plurality of candidate positions that are candidates for an installation position of the base station or the reflector in the radio area including a shielding object;
calculating received power between each of the terminal positions and each of the candidate positions and received power between each of the candidate positions and each of other candidate positions;
first selecting, for each of different numbers of base stations, a candidate position for the base station of the number of base stations from among the plurality of candidate positions;
second selecting, in a case where there is a terminal position that is not able to be accommodated by the candidate position for the base station among the plurality of terminal positions, a candidate position for the reflector capable of accommodating, in combination with the candidate position for the base station, the terminal position that is not able to be accommodated, and an orientation of the reflector; and
determining arrangement of the base station and the reflector in which a cost of the radio area is minimized from among candidate positions of the base station, or combinations of the candidate position for the base station, the candidate position for the reflector, and the orientation of the reflector.

8. A non-transitory computer readable storage medium storing a program for causing a computer to execute the station placement design method according to claim 7.
